(19) United States
(12) Patent Application Publication
(10) Pub. No.: US 2024/0376245 A1
(43) Pub. Date: Nov. 14, 2024

(54) COPOLYMERISATION OF ALDEHYDES AND VINYL ETHERS

(71) Applicant: BASF SE, Ludwigshafen Am Rhein (DE)

(72) Inventors: Guido Vandermeulen, Ludwigshafen (DE); Paul Lederhose, Ludwigshafen (DE); Szilard Csihony, Gorxheimertal (DE)

(73) Assignee: BASF SE, Ludwigshafen Am Rhein (DE)

(21) Appl. No.: 18/290,674

(22) PCT Filed: Mar. 24, 2022
(86) PCT No.: PCT/EP2022/057787

§ 371 Date: Jan. 19, 2024

(30) Foreign Application Priority Data
Jul. 23, 2021 (EP) 21187474.8

(51) Int. Cl. C08G 2/26; C08G 2/06

(52) U.S. Cl. CPC C08G 2/26; C08G 2/06

(57) ABSTRACT

A process for the manufacturing of copoly mers of aldehydes, vinyl ethers, and certain copolymers of aldehydes and vinyl ethers can be performed. The copolymerisation is carried out in the presence of at least one reactive boron trihalide complex, and optionally, in the presence of at least one Bronsted Acid and/or Lewis Base.

The present invention concerns a process for manufacturing of copolymers of aldehydes and vinyl ethers and certain copolymers of aldehydes and vinyl ethers.

Copolymers of aldehydes and vinyl ethers are known in the prior art, e.g. from results of the work group of Prof. Aoshima at Osaka University. In Macromolecules 2010, 43, 3141-3144 it is described how benzaldehydes and vinyl ethers are cationically copolymerised in the presence of GaCl₃ as Lewis Acid using ethane sulfonic acid as Brønsted Acid.

It is a disadvantage of this process that GaCl₃ is an expensive Lewis Acid and not available in industrial scale. In addition, the described process employs extensive drying of reagents before polymerisation. Drying towers and distillation of reagents are employed before copolymerisation is undertaken, most probably to ensure a low molecular weight distribution of the resulting polymers. Furthermore, the Macromolecules reference discloses only benzaldehyde and p-methoxy benzaldehyde as reactants and is silent about the use of other aldehydes.

From the same work group another Macromolecules reference was published (Macromolecules 2012, 45, 4060-4068) which discloses reaction of cycloaliphatic aldehydes, such as naturally occurring aldehydes. Furthermore, the use of FeCl₃/EtSO₃H and EtAlCl₂/EtSO₃H as catalyst was disclosed, however, the reported conversion was low although the reaction time was 48 hours. In the prior art furthermore copolymerisation of furfural was disclosed, see Aso et al., Die Makromolekulare Chemie 1973, 172, 85. In this reference inter alia BF₃·O(C₂H₅) is used as Lewis Acid for the polymerisation of furfural with e.g. p-tolyl vinyl ether, however, the reaction is allegedly reported to occur under opening of the furan ring. Despite the long reaction time reported, conversion rates are low and partly yield insoluble products.

It was an object of the present invention to find reaction conditions under which aldehydes and vinyl ethers undergo reaction and according to which aldehydes other than aromatic or cycloaliphatic aldehydes can be brought to reaction. Especially, a readily available Lewis Acid should be used together with a reaction time allowing an acceptable space-time-yield. In addition, the Lewis Acid used should be resilient so that there is no need to use dried reagents in the reaction.

The object was achieved by a process for copolymerisation of at least one vinyl ether (V) and at least one aldehyde (A), optionally in the presence of at least one solvent, characterised in that the copolymerisation is carried out in the presence of at least one reactive boron trihalide complex of the formula

BX₃×xROH

wherein
X is a halide, preferably selected from the group consisting of fluorine, chlorine, and bromine, more preferably selected from the group consisting of fluorine and chlorine, and especially fluorine,
ROH is an alcohol or water, preferably an alkanol, more preferably a linear or branched C₁-C₁₀-alkanol, even more preferably a linear or branched C₁-C₄-alkanol
x is a positive number of more than 0 (zero)
optionally in the presence of at least one Brønsted Acid (BA) and/or Lewis Base (LB) wherein the molar ratio of vinyl ethers (V):aldehydes (A) is from 10:1.2 to 1:1.2, preferably from 7:1.2 to 1:1.2, more preferably from 5:1.2 to 1:1.2, even more preferably from 3:1.2 to 1:1.2, and especially from 2:1.2 to 1:1.2.

It is an advantage compared to the documents pointed out above that the copolymerisation according to the present invention takes place in the presence of a complex based on boron trihalides as a Lewis Acid which is readily available even in industrial scale.

Suitable boron trihalides are boron trifluoride, boron trichloride, and boron tribromide, preferably boron trifluoride and boron trichloride, and more preferably boron trifluoride.

The boron trihalides are used as a complex (BX₃×x ROH) with at least one alcohol ROH or water, preferably one or two alcohols, and more preferably one alcohol.

In one embodiment of the present invention ROH may be water, i.e. R is hydrogen.

Alcohols ROH are selected from the group consisting of aliphatic, cycloaliphatic, and aromatic alcohols, preferably aliphatic or aromatic alcohols, and more preferably aliphatic alcohols.

The alcohol ROH may bear one or up to 4 hydroxy groups, preferably 1 to 3 hydroxy groups, more preferably 1 or 2 hydroxy groups, and especially 1 hydroxy group.

Aliphatic alcohols may be optionally substituted C₁- to C₂₀-aliphatic alcohols, preferably C₁- to C₂₀-alkanols, more preferably C₁- to C₁₀-alkanols, even more preferably C₁- to C₆-alkanols, and especially preferably C₁- to C₄-alkanols.

Cycloaliphatic alcohols may be optionally substituted C₅- to C₁₂-cycloaliphatic alcohols, preferably C₅- to C₁₂-cycloalkanols, more preferably C₅- to C₇-cycloalkanols, and especially C₅- to C₆-cycloalkanols.

Aromatic alcohols may be optionally substituted C₆- to C₁₂-aromatic alcohols.

Examples for the above-mentioned alcohols are methanol, ethanol, n-propanol, isopropanol, n-butanol, sec-butanol, isobutanol, tert-butanol, n-pentanol, n-hexanol, n-heptanol, n-octanol, 2-ethylhexanol, cyclohexanol, phenol, p-methoxyphenol, o-, m-and p-cresol, benzyl alcohol, p-methoxybenzyl alcohol, 1-and 2-phenylethanol, 1-and 2-(p-methoxyphenyl) ethanol, 1-, 2-and 3-phenyl-1-propanol, 1-, 2-and 3-(p-methoxyphenyl)-1-propanol, 1-and 2-phenyl-2-propanol, 1- and 2-(p-methoxyphenyl)-2-propanol, 1-, 2-, 3-and 4-phenyl-1-butanol, 1-, 2-, 3-and 4-(p-methoxyphenyl)-1-butanol, 1-, 2-, 3-and 4-phenyl-2-butanol, 1-, 2-, 3-and 4-(p-methoxy-phenyl)-2-butanol, 9-methyl-9H-fluoren-9-ol, 1,1-diphenylethanol, 1,1-diphenyl-2-propyn-1-ol, 1,1-diphenylpropanol, 4-(1-hydroxy-1-phenylethyl) benzonitrile, cyclopropyldiphenylmethanol, 1-hydroxy-1,1-diphenylpropan-2-one, benzilic acid, 9-phenyl-9-fluorenol, triphenylmethanol, diphenyl (4-pyridinyl) methanol, alpha, alpha-diphenyl-2-pyridinemethanol, 4-methoxytrityl alcohol (especially polymer-bound as a solid phase), alpha-tert-butyl-4-chloro-4′-methylbenzhydrol, cyclohexyldiphenylmethanol, alpha-(p-tolyl)-benzhydrol, 1, 1,2-triphenylethanol, alpha, alpha-diphenyl-2-pyridineethanol, alpha, alpha-4-pyridylbenzhydrol N-oxide, 2-fluorotriphenylmethanol, triphenylpropargyl alcohol, 4-[(diphenyl) hydroxymethyl]benzonitrile, 1-(2,6-dimethoxyphenyl)-2-methyl-1-phenyl-1-propanol, 1,1,2-triphenylpropan-1-ol and p-anisaldehyde carbinol.

Among these alcohols aliphatic alcohols are preferred, more preferred are the alkanols, and especially preferred are methanol, ethanol, n-propanol, iso-propanol, n-butanol, and tert. butanol.

“x” is the molar ratio of alcohol or water and boron trihalide in the complex BX₃×x ROH. According to the present invention “x” is a positive number of more than 0 (zero).

Preferably x may be 0.1 to 10, more preferably 0.2 to 5, even more preferably 0.3 to 3, very preferably 0.5 to 2, and especially 0.7 to 1.3.

Optionally the boron trihalide in the complex may further comprise at least one Brønsted Acid (BA) and/or at least one Lewis Base (LB).

The at least one Brønsted Acid (BA) is preferably selected from the group consisting of organic sulfonic acids and sulfuric acid, preferably sulfonic acids, more preferably aliphatic or aromatic sulfonic acids, even more preferably C₁- to C₄-alkyl sulfonic acids, especially methane sulfonic acid and ethane sulfonic acid. Examples for the less preferred aromatic sulfonic acids are optionally substituted C₆- to C₁₂-aromatic sulfonic acids, such as benzene sulfonic acid, p-toluene sulfonic acid, and para-C₆- to C₂₀-alkyl benzene sulfonic acid.

The at least one Lewis Base (LB) comprises at least one oxygen atom with at least one lone electron pair, preferably at least one oxygen atom with at least one lone electron pair, more preferably the Lewis Base is selected from the group consisting of organic compounds with at least one ether or ester function, especially preferably selected from the group consisting of ethers, preferably aliphatic or cycloaliphatic ethers, more preferably selected from the group consisting of di(C₁- to C₄-alkyl) ethers, tetrahydrofurane, tetrahydropyrane, and dioxane, and especially selected from the group consisting of tetrahydrofurane, tetrahydropyrane, and dioxane.

Using at least one Brønsted Acid (BA) and/or at least one Lewis Base (LB), the complex according to the invention follows the lowing formula

BX₃×x ROH×y BA×z LB

wherein

number “y” and “z” independently of another may be 0 (zero) or a positive number.

Preferably y may be 0 to 10, more preferably 0.1 to 5, even more preferably 0.15 to 3, very preferably 0.2 to 2, and especially 0.25 to 1.5.

Preferably z may be 0 to 500, more preferably 0 to 450, even more preferably 0 to 400, very preferably 0 to 350, and especially 0 to 300.

It is also possible to use aluminium or iron halides rather than the boron trihalide complex according to the invention.

Examples for aluminium halides are aluminium trihalides, alkylaluminium halides, and dialkylaluminium halides with aluminium trihalides being preferred.

A suitable aluminium trihalide, hereinafter referred to as AlX₃, is especially aluminium trifluoride, aluminium trichloride or aluminium tribromide, preferably aluminium trichloride.

A useful alkylaluminium halide is especially a mono (C₁- to C₄-alkyl) aluminium dihalide or a di(C₁- to C₄-alkyl) aluminium monohalide, for example methylaluminium dichloride, ethylaluminium dichloride, iso-butylaluminium dichloride, dimethylaluminium chloride or diethylaluminium chloride, diiso-butylaluminium chloride, preferably ethylaluminium dichloride, iso-butylaluminium dichloride, diethylaluminium chloride or diiso-butylaluminium chloride and very preferably ethylaluminium dichloride and iso-butylaluminium dichloride.

Especially suitable iron trihalides, hereinafter referred to as FeX₃, are iron trifluoride, iron trichloride or iron tribromide, preferably iron trichloride.

These Lewis Acids other than BX₃ may also be used in a complex as described above, i.e.

AlX₃×x ROH×y BA×z LB

respectively

FeX₃×x ROH×y BA×z LB

wherein

X, x, y, z, ROH, BA, and LB are defined as above.

Another object of the present invention is the use of such a complex for copolymerising vinyl ethers (V) and aldehydes (A).

Vinyl ethers (V) for use in the copolymerisation according to the present invention are C₁- to C₂₀-alkyl vinyl ethers, C₃- to C₂₀-alkenyl vinyl ethers, C₅- to C₁₂-cycloalkyl vinyl ethers, cyclic vinylethers, such as 2,3-dihydrofuran, 3,4-dihydropyran, vinyl ethers comprising alkylene glycol side chains, vinyl ethers comprising ester groups in the side chain, and C₆- to C₁₂-aryl vinyl ethers, preferably C₁- to C₂₀-alkyl vinyl ethers, C₃- to C₂₀-alkenyl vinyl ethers, and C₅- to C₁₂-cycloalkyl vinyl ethers, more preferably C₁- to C₂₀-alkyl vinyl ethers and C₃- to C₂₀-alkenyl vinyl ethers, and especially C₁- to C₂₀-alkyl vinyl ethers.

In one embodiment of the present invention the vinyl ether (V) may bear two or more vinyl ether groups, preferably two to six, more preferably two to four, even more preferably two to three, and especially exactly two.

Preferred vinyl ethers bearing two or more vinyl ether groups are vinyl ethers of polyols, preferably diols or polyols with a functionality of three or higher.

Diols used in accordance with the present invention include for example ethylene glycol, propane-1,2-diol, pro-pane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, hep-tane-1,2-diol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2-and 1,3-cyclopentanediols, 1,2-, 1,3-and 1,4-cyclo-hexanediols, 1,1-, 1,2-, 1,3-and 1,4-bis (hydroxymethyl) cyclohexanes, 1,1-, 1,2-, 1,3-and 1,4-bis(hydroxyethyl)cyclohexanes, neopentyl glycol, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂—CH₂O)ₙ—H or polypropylene glycols HO(CH(CH₃)—CH—O)ₙ—H, n being an integer and being at least 4, polyethylene-polypropylene glycols, the sequence of the ethylene oxide or propylene oxide units being blockwise or random, polytetramethylene glycols, preferably with a molar weight of up to 5000 g/mol, poly-1,3-propanediols, preferably with a molar weight up to 5000 g/mol, polycaprolactones, or mixtures of two or more representatives of the above compounds. Diols whose use is preferred are ethylene glycol, 1,2-propanediol, 1,3-propanediol, 1,4-butanediol, 1,5-pentanediol, 1,6-hexanediol, 1,8-octanediol, 1,2-, 1,3-and 1,4-cyclohexanediol, 1,3-and 1,4-bis (hydroxymethyl) cyclohexane, and diethylene glycol, triethylene glycol, dipropylene glycol and tripropylene glycol.

Alcohols with a functionality of at least three comprise glycerol, trimethylolmethane, trimethylolethane, trimethylolpropane, 1,2,4-butanetriol, tris(hydroxymethyl) amine, tris(hydroxyethyl) amine, tris(hydroxypropyl)amine, pentaerythritol, diglycerol, triglycerol or higher condensates of glycerol, di(trimethylolpropane), di(pentaerythritol), trishydroxymethyl isocyanurate, tris (hydroxyethyl) isocyanurate (THEIC), tris(hydroxypropyl) isocyanurate, inositols or sugars, such as glucose, fructose or sucrose, for example, sugar alcohols such as sorbitol, isosorbide, mannitol, threitol, erythritol, adonitol (ribitol), arabitol (lyxitol), xylitol, dulcitol (galactitol), maltitol, isomalt, polyetherols with a functionality of three or more, based on alcohols with a functionality of three or more and on ethylene oxide, propylene oxide and/or butylene oxide.

In the case of alcohols with a functionality of hydroxy groups of three or higher not necessary all hydroxy groups may be etherised with vinyl groups as long as the functionality of vinyl groups is at least two. In this case the functionality of vinyl groups may also be a rational number.

Examples for C₁- to C₂₀-alkyl vinyl ethers are methyl vinyl ether, ethyl vinyl ether, n-propyl vinyl ether, iso-propyl vinyl ether, n-butyl vinyl ether, sek-butyl vinyl ether, iso-butyl vinyl ether, tert-butyl vinyl ether, n-pentyl vinyl ether, n-hexyl vinyl ether, n-octyl vinyl ether, n-decyl vinyl ether, n-dodecyl vinyl ether, n-tetradecyl vinyl ether, n-hexadecyl vinyl ether, n-octadecyl vinyl ether, and n-eicosyl vinyl ether. Among those examples the C₁- to C₁₀-alkyl vinyl ethers are preferred and the C₁- to C₄-alkyl vinyl ethers very preferred, especially methyl vinyl ether, ethyl vinyl ether, iso-propyl vinyl ether, iso-butyl vinyl ether, and n-butyl vinyl ether.

Examples for C₃- to C₂₀-alkenyl vinyl ethers are allyl vinyl ether, tetradec-9-enyl vinyl ether, hexadec-9-enyl vinyl ether, octadec-9-enyl vinyl ether, octadec-11-enyl vinyl ether, octadec-9,12-dienyl vinyl ether, octadec-9,12,15-trienyl vinyl ether, and eicosa-5,8,11,14-tetraenyl vinyl ether.

Examples for cyclic vinyl ethers are 2,3-dihydrofuran and 3,4-dihydropyran.

Examples for vinyl ethers comprising alkylene glycol side chains are of formula

R¹—[—Xᵢ—]ₙ—O—HC═CH₂

wherein

R¹ is hydrogen or a linear or branched C₁- to C₂₀-alkyl, preferably hydrogen or C₁- to C₄-alkyl, more preferably hydrogen, methyl, ethyl or n-butyl, and especially hydrogen,

n is a positive integer from 1 to 25, preferably from 1 to 20, more preferably from 1 to 15, and most preferably from 1 to 10, and

Xᵢ is for every i from 1 to n selected from the group consisting of —O—CH₂—CH₂—, —O—CH₂—CH(CH₃)—, —O—CH(CH₃)—CH₂—, —O—CH₂—C(CH₃)₂—, —O—C(CH₃)₂—CH₂—, —O—CH₂—CH(C₂H₅)—, —O—CH(C₂H₅)—CH₂— und —O—CH(CH₃)—CH(CH₃)—, preferably selected from the group consisting of —O—CH₂—CH₂—, —O—CH₂—CH(CH₃)—, —O—CH(CH₃)—CH₂—, —O—CH₂—C(CH₃)₂—, —O—C(CH₃)₂—CH₂—, —O—CH₂—CH(C₂H₅)—, and —O—CH(C₂H₅)—CH₂—, more preferably selected from the group consisting of —O—CH₂—CH₂—, —O—CH₂—CH(CH₃)—, —O—CH(CH₃)—CH₂—, —O—CH₂—C(CH₃)₂—, and —O—C(CH₃)₂—CH₂—, most preferably selected from the group consisting of —O—CH₂—CH₂—, —O—CH₂—CH(CH₃)— and —O—CH(CH₃)—CH₂—, and especially —O—CH₂—CH₂—.

Examples for vinyl ethers comprising ester groups in the side chain of formula

R²—(C═O)—[—Xᵢ—]ₙ—O—HC═CH₂

wherein

R² is hydrogen or a linear or branched C₁- to C₂₀-alkyl or linear or branched C₂- to C₂₀-alkenyl, preferably hydrogen or a linear or branched C₁- to C₁₀-alkyl or linear or branched C₁₂- to C₂₀-alkenyl, n is a positive integer from 1 to 25, preferably from 1 to 20, more preferably from 1 to 15, and most preferably from 1 to 10, and

Xᵢ is for every i from 1 to n selected from the group consisting of —O—CH₂—CH₂—, —CH₂—CH(CH₃)—, —O—CH(CH₃)—CH₂—, —O—CH₂—C(CH₃)₂—, —O—C(CH₃)₂—CH₂—, —O—CH₂—CH(C₂H₅)—, —O—CH(C₂H₅)—CH₂— und —O—CH(CH₃)—CH(CH₃)—, preferably selected from the group consisting of —O—CH₂—CH₂—, —O—CH₂—CH(CH₃)—, —O—CH(CH₃)—CH₂—, —O—CH₂—C(CH₃)₂—, —O—C(CH₃)₂—CH₂—, —O—CH₂—CH(C₂H₅)—, and —O—CH(C₂H₅)—CH₂—, more preferably selected from the group consisting of —O—CH₂—CH₂—, —O—CH₂—CH(CH₃)—, —O—CH(CH₃)—H₂—, —O—CH₂—C(CH₃)₂—, and —O—C(CH₃)₂—CH₂—, most preferably selected from the group consisting of —O—CH₂—CH₂—, —O—CH₂—CH(CH₃)— and —O—CH(CH₃)—CH₂—, and especially —O—CH₂—CH₂—.

Examples for C₆- to C₁₂-aryl vinyl ethers are phenyl vinyl ether, tolyl vinyl ether, and naphtyl vinyl ether.

An example for a vinyl ether comprising ester groups in the side chain is vinyloxyethyl malonate (VOEM).

Among the above-mentioned vinyl ethers C₁- to C₂₀-alkyl vinyl ethers and C₃- to C₂₀-alkenyl vinyl ethers are preferred, and more preferably the C₁- to C₂₀-alkyl vinyl ethers, even more preferably C₁- to C₁₀-alkyl vinyl ethers, very preferably C₁- to C₄-alkyl vinyl ethers, and especially methyl vinyl ether, ethyl vinyl ether, n-propyl vinyl ether, iso-propyl vinyl ether, n-butyl vinyl ether, iso-butyl vinyl ether, and tert-butyl vinyl ether.

In one embodiment of the present invention the vinyl ether is a long chain aliphatic vinyl ether selected from the group consisting of C₁₀- to C₂₀-alkyl vinyl ethers and C₁₀- to C₂₀-alkenyl vinyl ethers, preferably C₁₀- to C₂₀-alkyl vinyl ethers.

Preferably in this embodiment the vinyl ether (V) is selected from the group consisting of n-decyl vinyl ether, 3,7-dimethyloct-6-en-1-yl vinyl ether, 3,7-dimethyl-7-octen-1-yl vinyl ether, (E)-3,7-dimethyl-2,6-octadien-1-yl vinyl ether, (Z)-3,7-dimethyl-2,6-octadien-1-yl vinyl ether, n-dodecyl vinyl ether, n-tetradecyl vinyl ether, n-hexadecyl vinyl ether, n-octadecyl vinyl ether, n-eicosyl vinyl ether, tetradec-9-enyl vinyl ether, hexadec-9-enyl vinyl ether, octadec-9-enyl vinyl ether, octadec-11-enyl vinyl ether, octadec-9,12-dienyl vinyl ether, octadec-9,12,15-trienyl vinyl ether, and eicosa-5,8,11,14-tetraenyl vinyl ether.

In another embodiment of the present invention the vinyl ether is a cycloalkyl vinyl ether, preferably a C₅- to C₁₂-cycloalkyl vinyl ether, more preferably a C₅- to C₆-cycloalkyl vinyl ether.

Examples for C₅- to C₁₂-cycloalkyl vinyl ethers are cyclopentyl vinyl ether, cyclohexyl vinyl ether, cycloheptyl vinyl ether, and cyclododecyl vinyl ether, especially cyclohexyl vinyl ether.

Aldehydes (A) for use in the copolymerisation according to the present invention are selected from the group consisting of optionally substituted C₆- to C₁₂-aromatic aldehydes, furfural aldehydes, C₁- to C₁₀₀-aliphatic aldehydes, one-or multifold unsaturated C₃- to C₂₀-aliphatic aldehydes, preferably alpha, beta-unsaturated C₃- to C₂₀-aliphatic aldehydes, and C₅-to C₁₂-cycloaliphatic aldehydes, preferably selected from the group consisting of optionally substituted C₆- to C₁₂-aromatic aldehydes and C₁- to C₂₀-aliphatic aldehydes.

C₆- to C₁₂-aromatic aldehydes are optionally substituted benzaldehyde, 1-naphthaldehyde, and 2-naphthaldehyde.

Preferred is optionally substituted benzaldehyde of formula

R³-Ph-CHO

wherein

Ph is a benzene ring and

R³ is selected from the group consisting of hydrogen, C₁- to C₂₀-alkyl, C₁- to C₂₀-alkyloxy, and R⁴R⁵N—,

R⁴ and R⁵ independently of another are C₁- to C₄-alkyl or together with the nitrogen atom form a five-to seven-membered ring.

Substituent R³ and the aldehyde group —CHO are preferably located in position 2 or 4 to each other, preferably in position 4.

Examples of R³ are hydrogen, methyl, ethyl, n-propyl, iso-propyl, n-butyl, sek-butyl, iso-butyl, tert-butyl, n-pentyl, n-hexyl, n-octyl, 2-ethylhexyl, n-decyl, 2-propylheptyl, n-dodecyl, n-tetradecyl, n-hexadecyl, n-octadecyl, n-eicosyl, methoxy, ethoxy, tert.-butoxy, 2-ethylhexyloxy, and dimethylamino, preferably hydrogen, methyl, methoxy, and dimethylamino.

Preferred aromatic aldehydes are benzaldehyde, tolualdehyde, vanillin, p-methoxy benzaldehyde,

Preferred C₁- to C₁₀₀-aliphatic aldehydes are linear or branched C₁- to C₁₀₀-alkanals or linear or branched C₃- to C₁₀₀-alkenals, in which the double bond may be isolated or conjugated with the aldehyde group.

In one embodiment of the present invention the aldehyde is a low molecular, aliphatic, saturated or unsaturated, linear or branched C₁- to C₉-aldehyde, preferably saturated C₁- to C₉-aldehyde, more preferably selected from the group consisting of formaldehyde, acetaldehyde, propionaldehyde, butyraldehyde, iso valeraldehyde, hexanal and 2-ethylhexyl aldehyde.

In one embodiment of the present invention the aldehyde is a medium molecular, aliphatic, saturated or unsaturated, linear or branched C₁₀- to C₂₀-aldehyde, preferably branched unsaturated C₁₀- to C₂₀-aldehyde, more preferably selected from the group consisting of undecanal, tridecanal, pentadecanal, heptadecanal, and citronellal.

In one embodiment of the present invention the aldehyde is a high molecular, aliphatic, saturated or unsaturated, linear or branched C₃₅- to C₁₀₀-aldehyde, preferably C₅₀- to C₇₅-aldehyde.

Such aldehydes are preferably obtainable by Lewis Acid-catalysed polymerisation of a propene, 1-butene or isobutene to a polyolefin bearing an unsaturated terminal group, followed by hydroformylation to the corresponding aldehyde.

Hydroformylation is described e.g. in U.S. Pat. No. 6,331,656 B1, preferably from column 2, line 54 to column 5, line 34, very preferably form column 4, line 24 to column 5, line 8, which is incorporated into the present disclosure by reference.

Preferably the aldehyde is selected from the group consisting of aldehydes obtained from hydroformylation or photooxygenation of oligo/polyisobutene with a number average molecular weight of from 100 to 1500, more preferably from 200 to 1200, and very preferably from 250 to 1100.

In one embodiment of the present invention the aldehyde is an alpha, beta-unsaturated C₃- to C₂₀-aliphatic aldehyde, which optionally may be substituted and is linear or branched. Examples are acrolein, methacrolein, crotonaldehyde, 3-hexenal, cis-4-heptenal, 2-ethylhexenal, decenal, 2-propylheptenal, citral, geranial, neral, and cinnamaldehyde.

C₅- to C₁₂-cycloaliphatic aldehydes may be cyclopentane aldehyde, cyclohexane aldehyde, and cyclododecane aldehyde.

The copolymers according to the invention and obtainable according to the process according to the present invention exhibits a weight average molecular weight M_{w} of from 1000 to 40000, preferably from 5000 to 30000, more preferably from 6000 to 25000 g/mol, determined by gel permeation chromatography.

The process according to the present invention usually yields copolymers with a polydispersity from 1 to 5, preferably from 1.1 to 3, more preferably from 1.2 to 2.5.

In the embodiment according to which the vinyl ether (V) bears two or more vinyl ether groups the weight average molecular weight M_{w} may be from 10000 to 150000, preferably from 15000 to 100000, more preferably from 20000 to 90000 g/mol, determined by gel permeation chromatography.

In the latter embodiment the process according to the present invention usually yields copolymers with a polydispersity from 1 to 10, preferably from 1.1 to 8, more preferably from 1.2 to 6.

Another subject of the present invention is a process for copolymerisation of at least one vinyl ether (V) and at least one aldehyde (A), optionally in the presence of at least one solvent, characterised in that the copolymerisation is carried out in the presence of at least one boron trihalide complex described above, optionally in the presence of at least one Brønsted Acid (BA) and/or Lewis Base (LB).

In the process the at least one vinyl ether (V) and the at least one aldehyde (A) is brought to reaction in a molar ratio of vinyl ethers (V):aldehydes (A) from 10:1.2 to 1:1.2, preferably from 7:1.2 to 1:1.2, more preferably from 5:1.2 to 1:1.2, even more preferably from 3:1.2 to 1:1.2, and especially from 2:1.2 to 1:1.2.

The copolymerisation in the process according to the invention may optionally be conducted in the presence of an inert solvent. The inert solvent used should be suitable for reducing the increase in the viscosity of the reaction solution which generally occurs during the polymerisation reaction to such an extent that the removal of the heat of reaction which evolves can be ensured. In addition, the selected solvent needs to ensure monomer/polymer solubility even at the low reaction temperature employed. Suitable solvents are those solvents or solvent mixtures which are inert toward the reagents used. Suitable solvents are, for example, aliphatic hydrocarbons such as n-butane, n-pentane, n-hexane, n-heptane, n-octane and isooctane, cycloaliphatic hydrocarbons such as cyclopentane and cyclohexane, aromatic hydrocarbons such as benzene, toluene and the xylenes, and halogenated hydrocarbons, especially halogenated aliphatic hydrocarbons, such as methyl chloride, dichloromethane and trichloromethane (chloroform), 1,1-dichloroethane, 1,2-dichloroethane, trichloroethane and 1-chlorobutane, and also halogenated aromatic hydrocarbons and alkylaromatics halogenated in the alkyl side chains, such as chlorobenzene, monofluoromethylbenzene, difluoromethylbenzene and trifluoromethylbenzene, and mixtures of the aforementioned solvents. A non-halogenated solvent is preferred over the list of halogenated solvents.

The inventive copolymerisation may be performed in a halogenated hydrocarbon, especially in a halogenated aliphatic hydrocarbon, or in a mixture of halogenated hydrocarbons, especially of halogenated aliphatic hydrocarbons, or in a mixture of at least one halogenated hydrocarbon, especially a halogenated aliphatic hydrocarbon, and at least one aliphatic, cycloaliphatic or aromatic hydrocarbon as an inert solvent, for example a mixture of dichloromethane and n-hexane, typically in a volume ratio of 10:90 to 90:10, especially of 50:50 to 85:15.

The reaction time of the copolymerisation usually is 0.5 to 24 hours, preferably 1 to 10 hours, and more preferably 1.5 to 7 hours.

The copolymerisation is usually carried out at a temperature of from −90 to 0° C., preferably from −80 to −20° C., more preferably from −78 to −34° C.

The tuning of reaction time and temperature depends on the reactivity of aldehyde (A), vinyl ether (V), and boron trihalide complex used. It may be necessary to systematically vary reaction time, temperature, and boron trihalide complex in order to optimise yield and selectivity of the copolymerisation.

Next to the polymer, also a certain amount of trimer/oligomers is being formed. Aoshima has also reported these side products with GaCl₃, while similar amounts of trimer/oligomers were found with BF₃.

After the reaction has reached the desired conversion, the copolymerisation is stopped by quenching with at least one of alcohols, water, ammonia, amines, hydroxides, carbonates, and hydrogen carbonates. Ammonia, amines, hydroxides, carbonates, and hydrogen carbonates may also be used as aqueous solutions.

Alcohols may for example be the above-mentioned alcohols ROH, preferably ethanol.

Water and alcohols are preferred among the mentioned quenching agents.

The quenching agent is used at least in amounts sufficient to deactivate the boron trihalide complex.

Especially in the case of water or aqueous solutions as quenching agent the aqueous phase furthermore acts to extract hydrolysed products of the boron trihalide complex from the reaction mixture or water-soluble by-products.

Quenching usually occurs at the reaction temperature at which the copolymerisation is conducted and usually only takes a few seconds to several minutes to happen. After quenching is completed the reaction mixture is allowed to warm up to the desired temperature at which the reaction mixture shall further be processed, preferably to room temperature.

Optionally, the copolymers can be purified using an extraction procedure which removes residual monomer and/or salts.

In a preferred embodiment a further processing of the reaction mixture comprises the hydrolysis of the copolymer obtained according to the reaction according to the invention.

For the hydrolysis the copolymer is optionally dissolved in at least one solvent and reacted with water in the presence of at least one Brønsted Acid with a pKₐ-value of not more than 3.0, more preferably not more than 2.0.

The solvent in the hydrolysis step may be the same of different from the solvent in which the copolymerisation is carried out.

Preferably an inert organic solvent is used which is water soluble so that the reaction mixture is well mixed with the Brønsted Acid used which usually is an aqueous solution. Examples for such solvents are ethers, especially tetrahydrofurane and dioxane.

Examples of Brønsted Acids are hydrochloric acid, sulfuric acid, phosphoric acid, nitric acid, methane sulfonic acid, ethane sulfonic acid, benzene sulfonic acid, p-toluene sulfonic acid, and para-C₆- to C₂₀-alkyl benzene sulfonic acid, preferably in their aqueous solutions. Very preferably hydrochloric acid, phosphoric acid, and sulfuric acid are used, especially hydrochloric acid and phosphoric acid.

The reaction mixture to which the Brønsted Acid is added is stirred for a time of from 0.5 to 96 hours, preferably from 1 to 48 hours at a hydrolysis temperature of from 0° C. to 60° C., preferably from ambient temperature to 40° C.

After the hydrolysis is completed the reaction mixture is neutralised, preferably with aqueous solutions of (earth) alkaline metal hydroxides, -carbonates, or -hydrogen carbonates.

Further water immiscible organic solvent may be added and the organic phase is washed one or several times with water or brine.

Afterwards the organic phase may be used as such or the solvent or solvents used may be distilled off at reduced temperature.

The product of the hydrolysis is an alpha, beta-unsaturated aldehyde based upon aldehyde (A) which is extended by two further carbon atoms now forming C₁ and C₂ of the newly formed alpha, beta-unsaturated aldehyde. The CHO-group of aldehyde (A) now forms C₃ of the newly formed alpha, beta-unsaturated aldehyde.

Hence, for example benzaldehyde may be converted into cinnamyl aldehyde using the copolymerisation according to the present invention followed by hydrolysis of the resulting copolymer.

Furthermore, if aldehydes from natural sources are used as comonomers, such as benzaldehyde, citronellal or citral, the resulting copolymer can be produced using sustainable resources.

With the appropriate choice of aldehyde and vinyl ether only environmentally friendly degradation products are released.

The examples which follow are intended to illustrate the present invention in detail without restricting it.

### EXAMPLES

### Preparation of BF₃·MeOH

10 g of dry methanol were placed in a stirred vessel and purged with gaseous BF₃ under inert conditions at −20° C. The determination of BF₃ to methanol ratio was performed via elemental analysis.

### Typical Polymerisation Procedure

Reagents were not distilled or dried before use, but used as obtained. Polymerisation was carried out under a dry nitrogen atmosphere in a 500 mL baked glass tube equipped with a four-way stopcock. The pre-chilled Brønsted acid was added to a stirred pre-chilled mixture of the monomers, the Lewis Base (optional) and 200 mL toluene at 0° C. The temperature was subsequently lowered to −78° C. and the reaction was started by the addition via dry medical syringe of pre-chilled Lewis acid. The reaction mixture was magnetically stirred throughout the polymerization. After a reaction time of 2-6 hours, the polymerization was quenched with pre-chilled methanol containing a small amount of ammonia solution. The quenched reaction mixture was diluted with dichloromethane and then washed with water to remove the initiator residues. After filtration, the solvent and other volatiles were evaporated under reduced pressure (50° C., 5 mbar), and the residue was vacuum-dried for at least 6 h at 50° C. The monomer conversion was determined by ¹H NMR, molecular weight and molecular weight distribution by GPC in THF against polystyrene standards.

### Typical Extraction Procedure (Optional)

The obtained copolymer was washed two times with methanol. Each time, the upper methanol phase was discarded. The obtained viscous or solid residue was subsequently dried under reduced pressure (50° C., 5 mbar). The copolymer was dissolved in few dichloromethane and placed on a foil. Solvent was allowed to evaporate and the obtained film was dried at 50° C., 10 mbar overnight. In some cases, a white powder was obtained by milling of the film in a milling apparatus.

### Typical Hydrolysis Procedure

The copolymer was dissolved in few THF under magnetic stirring. A 1.0 M acid solution was added and the mixture was stirred for 4 days at room temperature. Then, aqueous NaOH was added. The mixture was diluted with dichloromethane and the two phases were separated by extraction. The organic phase was washed three times with water after which the solvents were evaporated at 25-50° C., 5 mbar to (typically) obtain a transparent, oily or solid product.

TABLE 1
Overview of examples.

| | | | | | | | | Residual |
|---|---|---|---|---|---|---|---|---|
| | | | | Brønsted | Lewis | M_{w} | | Aldehyde |
| # | VE | Aldehyde | Lewis Acid | Acid | Base | (g/mol) | PDI | (%) |
| 1 (C) | 0.15 | 0.15 mol | 1 mmol | 1 mmol | 0.25 | 15700 | 2.0 | 14 |
| | mol | Anisaldehyde | GaCl₃ | EtSO₃H | mol | | | |
| | IBVE | | | | dioxane | | | |
| 2 (C) | 0.15 | 0.15 mol | 1 mmol | 1 mmol | 0.25 | No polymer | | 78 |
| | mol | Anisaldehyde | BF₃•(OEt)₂ | MeSO₃H | mol | | | |
| | IBVE | | | | dioxane | | | |
| 3 (C) | 0.15 | 0.15 mol | 1.5 mmol | 1 mmol | 0.25 | No polymer | | 83 |
| | mol | Anisaldehyde | BF₃•(OEt)₂ | MeSO₃H | mol | | | |
| | IBVE | | | | dioxane | | | |
| 4 | 0.15 | 0.15 mol | 1 mmol | 1 mmol | 0.25 | 14700 | 2.2 | 20 |
| | mol | Anisaldehyde | BF₃•(0.92 Me—OH) | MeSO₃H | mol | | | |
| | IBVE | | | | dioxane | | | |
| 5 | 0.15 | 0.15 mol | 1 mmol | 0.83 | 0.25 | 17400 | 2.3 | 20 |
| | mol | Anisaldehyde | BF₃•(0.92 MeOH | mmol | mol | | | |
| | IBVE | | | MeSO₃H | dioxane | | | |
| 6 | 0.15 | 0.15 mol | 1 mmol | 1 mmol | 0.125 | 18800 | 2.7 | 17 |
| | mol | Anisaldehyde | BF₃•(0.92MeOH) | MeSO₃H | mol | | | |
| | IBVE | | | | dioxane | | | |
| 7 | 0.15 | 0.15 mol | 1.5 mmol | 1 mmol | 0.25 | 13200 | 2.1 | 22 |
| | mol | Anisaldehyde | BF₃•(0.92MeOH) | MeSO₃H | mol | | | |
| | IBVE | | | | dioxane | | | |
| 8 | 0.15 | 0.15 mol | 0.5 mmol | 1 mmol | 0.25 | 18000 | 2.5 | 16 |
| | mol | Anisaldehyde | BF₃•(0.92MeOH) | MeSO₃H | mol | | | |
| | IBVE | | | | dioxane | | | |
| 9 | 0.15 | 0.15 mol | 1 mmol | 1 mmol | 0.25 | 20900 | 2.8 | n.d. |
| | mol | Benzaldehyde | BF₃•(0.92MeOH) | MeSO₃H | mol | | | |
| | IBVE | | | | dioxane | | | |
| 10 | 0.15 | 0.15 mol Cis- | 1 mmol | 1 mmol | 0.25 | 14600 (RI) | 4.3 | <1 |
| | mol | 4-heptene-1-al | BF₃•(0.92MeOH) | MeSO₃H | mol | | | |
| | IBVE | | | | dioxane | | | |
| 11 | 0.15 | 0.15 mol | 1 mmol | 1 mmol | 0.25 | 10700 | 2.1 | 26 |
| | mol | Anisaldehyde | BF₃•(0.92MeOH) | MeSO₃H | mol | | | |
| | EVE | | | | dioxane | | | |
| 12 | 0.15 | 0.15 mol | 1 mmol | 1 mmol | 0.25 | 8800 (RI) | 1.6 | <1 |
| | mol | Trans-2- | BF₃•(0.92MeOH) | MeSO₃H | mol | | | |
| | IBVE | decenal | | | dioxane | | | |
| 13 | 0.15 | 0.15 mol | 1 mmol | 1 mmol | none | 15000 | 2.2 | 23 |
| | mol | Anisaldehyde | BF₃•(0.92MeOH) | MeSO₃H | | | | |
| | IBVE | | | | | | | |
| 14 | 0.15 | 0.15 mol | 1 mmol | 1 mmol | 0.25 | 9700 | 1.7 | 4 |
| | mol | Furfural | BF₃•(0.92MeOH) | MeSO₃H | mol | | | |
| | IBVE | | | | dioxane | | | |
| 15 | 0.15 | 0.15 mol | 1 mmol | 1 mmol | 0.25 | 26000 | 1.4 | 15 |
| | mol | Anisaldehyde | BF₃•(0.92MeOH) | MeSO₃H | mol | | | |
| | IBVE + | | | | dioxane | | | |
| | 7.5 | | | | | | | |
| | mmol | | | | | | | |
| | TEG- | | | | | | | |
| | DVE | | | | | | | |
| 16 | 0.15 | 0.15 mol | 1 mmol | 1 mmol | 0.25 | 59000 | 2.9 | 11 |
| | mol | Anisaldehyde | BF₃•(0.92MeOH) | MeSO₃H | mol | | | |
| | IBVE + | | | | dioxane | | | |
| | 15 | | | | | | | |
| | mmol | | | | | | | |
| | TEG- | | | | | | | |
| | DVE | | | | | | | |

VE: vinyl ether
IBVE: iso-butyl vinyl ether
EVE: ethyl vinyl ether
TEG-DVE = triethylene glycol divinyl ether
MeOH: methanol
EtSO₃H/MeSO₃H: ethane/methane sulfonic acid
n.d. = not determined
Mw measured using UV-detection of crude polymer unless explicitly stated to be determined using RI-detection
(C): Comparative Example
Residual aldehyde: as determined in the crude polymer by ¹H-NMR spectroscopy. After extraction, the residual aldehyde levels after typically <1%.

A comparison of comparative Example 1 with Examples 4 to 6 shows comparable conversion rates and molecular weight as with GaCl₃, however, with the much easier to handle catalyst complex BF₃·(0.92MeOH) according to the present invention.

The catalyst system BF₃·(OEt)₂ does not yield any significant amounts of a copolymer of anisaldehyde and iso-butyl vinyl ether.

A comparison of Example 4 with Examples 15 and 16 shows an increase in the glass temperature of the polymer as measured by differential scanning calorimetry (DSC). This can be explained by the higher molecular weight/crosslinking of Example 15 and 16 versus Example 4.

| | Addition of | | Mw | T_{g} |
|---|---|---|---|---|
| Example | TEG-DVE | | (g/mol) | (° C.) |
| Example 4 | None | | 14700 | 27 |
| Example 15 | 7.5 | mmol | 25600 | 32 |
| Example 16 | 15 | mmol | 59400 | 34 |

1. A process, comprising:
copolymerising at least one vinyl ether (V) and at least one aldehyde (A), optionally in the presence of at least one solvent,
wherein the copolymerisation is carried out in the presence of at least one reactive boron trihalide complex of the formula
BX₃×x ROH
wherein
X is a halide,
ROH is an alcohol or water, and
x is a positive number of more than 0(zero),
optionally in the presence of at least one Brønsted Acid (BA) and/or Lewis Base (LB), wherein a molar ratio of the at least one vinyl ether (V):the at least one aldehyde (A) is from 10:1 to 1:1.

2. The process according to claim 1, wherein the alcohol ROH is at least one selected from the group consisting of methanol, ethanol, n-propanol, iso-propanol, n-butanol, and tert.butanol.

3. The process according to claim 1, wherein the Bronsted Acid (BA) is at least one selected from the group consisting of organic sulfonic acids and sulfuric acid.

4. The process according to claim 1, wherein the Lewis Base (LB) is at least one selected from the group consisting of ethers and esters.

5. The process according to claim 1, wherein the vinyl ethers (V) are C₁- to C₂₀-alkyl vinyl ethers, C₃- to C₂₀-alkenyl vinyl ethers, C₅- to C₁₂-cycloalkyl vinyl ethers, cyclic vinylethers, vinyl ethers comprising alkylene glycol side chains, vinyl ethers comprising ester groups in the side chain, and C₆- to C₁₂-aryl vinyl ethers.

6. The process according to claim 1, wherein the at least one vinyl ether (V) bears two or more vinyl ether groups.

7. The process according to claim 1, wherein the at least one aldehyde (A) is at least one selected from the group consisting of optionally substituted C₆- to C₁₂-aromatic aldehydes, C₁- to C₁₀₀-aliphatic aldehydes, one- or multifold unsaturated C₃- to C₂₀-aliphatic aldehydes, and C₅- to C₁₂-cycloaliphatic aldehydes.

8. The process according to claim 1, wherein the copolymerisation is carried out at a temperature of from −90 to 0° C.

9. The process according to claim 1, wherein the copolymerisation is carried out for 0.5 to 24 hours.

10. The process according to claim 1, wherein the copolymerisation is stopped by quenching with at least one selected from the group consisting of alcohols, water, ammonia, amines, hydroxides, carbonates, and hydrogen carbonates.

11. A copolymer, comprising:
a polymerised form of at least one vinyl ether (V) and at least one aldehyde (A), wherein the at least one aldehyde (A) is an aliphatic aldehyde, wherein a molar incorporation ratio of the at least one vinyl ether (V):the at least one aldehyde (A) is from 10:1 to 1:1.

12. A copolymer, comprising:
a polymerised form of at least one vinyl ether (V) and at least one aldehyde (A), wherein the at least one vinyl ether (V) is a C₅- to C₁₂-cycloalkyl vinyl ether, wherein a molar incorporation ratio of the at least one vinyl ether (V):the at least one aldehyde (A) is from 10:1 to 1:1.

13. A copolymer, comprising:
a polymerised form of at least one vinyl ether (V) and at least one aldehyde (A), wherein the at least one vinyl ether (V) is at least one selected from the group consisting of C₁₀- to C₂₀-alkyl vinyl ethers and C₁₀- to C₂₀-alkenyl vinyl ethers, wherein a molar incorporation ratio of the at least one vinyl ether (V):the at least one aldehyde (A) is from 10:1 to 1:1.

14. The copolymer according to claim 11, wherein a polydispersity is from 1 to 5.

15. The copolymer according to claim 11, wherein a weight average molecular weight M_{w} is from 1000 to 40000.

16. A process for hydrolysis of a copolymer according to claim 11, the process comprising:
reacting the the copolymer, optionally dissolved in at least one solvent, with water in the presence of at least one Brønsted Acid with a pKₐ-value of not more than 3.0.

17. The process according to claim 1, wherein X is fluorine.

18. The process according to claim 1, wherein ROH is a linear or branched C₁-C₄-alkanol.

19. The process according to claim 1, wherein the molar ratio of the at least one vinyl ether (V):the at least one aldehyde (A) is from 2:1.2 to 1:1.2.

20. The process according to claim 1, wherein the Brønsted Acid (BA) is at least one selected from the group consisting of methane sulfonic acid and ethane sulfonic acid.
